(19) United States
(12) Patent Application Publication
(10) Pub. No.: US 2005/0282598 A1
(43) Pub. Date: Dec. 22, 2005

(54) Antenna and a handle for an electronic device

(76) Inventor: Lawrence A. Hinkey, Rhinebeck, NY (US)

Correspondence Address: HESLIN ROTHENBERG FARLEY & MESITI PC, 5 COLUMBIA CIRCLE, ALBANY, NY, 12203, US

(21) Appl. No.: 10/871,927

(22) Filed: Jun. 18, 2004

(51) Int. Cl. H04M 1/00

(52) U.S. Cl. 455/575.7; 455/575.1

(57) ABSTRACT

An article of manufacture that can function as a handle, an antenna, or a combination of handle and antenna is provided. Aspects of the invention facilitate the handling of electronic devices, for example, cell phones, or non-electronic objects, such as tools. In one aspect, the article includes a mounting device adapted to mount to an object and a wire, wherein the wire is self-extending from a constrained, deformed position to an extended, undeformed position. The self-extending feature may be provided by the angle of attachment of the wire to the mounting device, for example, a mounting pin. Though applicable for use with many kinds of electronic devices and non-electronic objects, aspects of the invention may be used to provide a handle and antenna for a cell phone that is mountable to the antenna port of a cell phone.

### TECHNICAL FIELD

The present invention generally relates to wire-like handles for facilitating the handling of personal items. More particularly, the present invention relates to wire-like handles for facilitating the handling of electronic devices, such as cell phones.

### BACKGROUND INFORMATION

In the early twenty-first century, the cell phone has become a staple of modern living. With the reduction in the cost of cell phone service, the availability of cell phones, and the social and commercial advantages, cell phones have become a standard personal accessory. However, the cell phone's compact size and shape often makes the cell phone difficult for the user handle. For example, the often sleek compact designs of contemporary cell phone often make them difficult to grasp either during use or when extracting the cell phone from a handbag or pocket. Anecdotal stories of users dropping or losing a cell phone when the phone slipped out of the user's grasp are common. In response to the recognized need, aspects of the invention provide a handle-type device to facilitate the handling of a cell phone.

Moreover, the inventor recognized that the disadvantages to handling cell phones also characterize the handling of other hand-held objects, for example, other hand-held electronic devices, for example, conventional phones, personal digital assistants, radios, calculators, computers, audio devices (for example, MP3-type players and Sony® iPod™ devices). In addition, non-electronic devices, objects, personal items, and implements, for example, tools, keys, wallets, pens, and related items may also be difficult to handle or to maintain a grip upon. Thus, aspects of the present invention may also be applicable to handling these electronic devices and other non-electronic objects and items.

Aspects of the present invention address this need to provide a means of facilitating the handling of electronic devices, such as cell phones, and non-electronic items, such as tools.

### SUMMARY OF THE INVENTION

One aspect of the invention is an article of manufacture comprising: a mounting device adapted to mount to an object; and a wire having a first end mounted to the mounting device and a second end mounted to the mounting device, wherein the wire is self-extending from a constrained, deformed position to an extended, undeformed position. In one aspect of this invention, the wire comprises one of a metallic and a non-metallic wire. In another aspect of the invention, the article of manufacture comprises a handle and the object is an electronic device, such as a cell phone.

Another aspect of the invention is a method for handling an object, the method comprising: providing an article of manufacture comprising: a mounting device adapted to mount to the object; and a wire having a first end mounted to the mounting device and a second end mounted to the mounting device; mounting the article of manufacture to the object; collapsing the wire of the article of manufacture to a deformed position; and inserting the object with the wire in the deformed position into a cavity. In one aspect of this method, the mounting device comprises a threaded mounting device and the object comprises a threaded port, wherein mounting the mounting device to the article comprises threading the threaded mounting device into the threaded port of the object. In another aspect of the invention, the cavity may be a pocket, a bag, a box, and a compartment, among others.

A further aspect of the invention is an antenna for a cell phone having an antenna mounting port, the antenna comprising: a mounting device adapted to mount to the antenna mounting port of the cell phone; and a wire having a first end mounted to the mounting device and a second end mounted to the mounting device; wherein the wire is self-extending from a constrained, deformed position to a free, undeformed position. In one aspect of this invention, the mounting device may include a mounting pin having an axis and wherein the first end and the second end of the wire are mounted at an angle α to the axis of the mounting pin.

These, and other objects, features and advantages of this invention will become apparent from the following detailed description of the various aspects of the invention taken in conjunction with the accompanying drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a plan view showing one aspect of the present invention as representatively mounted to a cell phone.

FIG. 2 is a side elevation view of the assembly shown in FIG. 1.

FIG. 3 is a detailed view of a mounting shown in FIG. 1 according to one aspect of the present invention, as identified by detail 3 in FIG. 1.

FIG. 4 is a side elevation view, partially in cross-section, of a mounting according to another aspect of the invention.

FIG. 5 is side elevation view, partially in cross section, of the aspect of the invention shown in FIG. 4 as viewed along view lines 5-5.

FIG. 6 is plan view of the aspect of the invention shown in FIG. 5 as viewed along view lines 6-6.

FIG. 7 is an exploded view of the mounting shown in FIGS. 4, 5 and 6.

FIG. 8 is a side elevation view, partially in cross-section, of a mounting according to another aspect of the invention.

FIG. 9 is side elevation view, partially in cross-section, of the aspect of the invention shown in FIG. 8 as viewed along view lines 9-9.

FIG. 10 is plan view of the aspect of the invention shown in FIG. 9 as viewed along view lines 10-10.

FIG. 11 is an exploded view, partially in cross section, of the mounting shown in FIGS. 8, 9, and 10.

FIG. 12 is a plan view of another aspect of the invention.

FIG. 13 is a side view of the aspect of the invention shown in FIG. 12.

FIG. 14 is side elevation view of another aspect of the invention.

FIG. 15 is a sectional view of the aspect of the invention shown in FIG. 14 as viewed along view lines 15-15.

FIG. 16 through 21 illustrate plan views of representative shapes of several aspects of the invention.

FIGS. 22 and 23 illustrate plan views of further aspects of the invention.

FIGS. 24 and 25 illustrate detailed views of the mounting arrangements for the aspects shown in FIGS. 22 and 23.

### DETAILED DESCRIPTION OF THE INVENTION

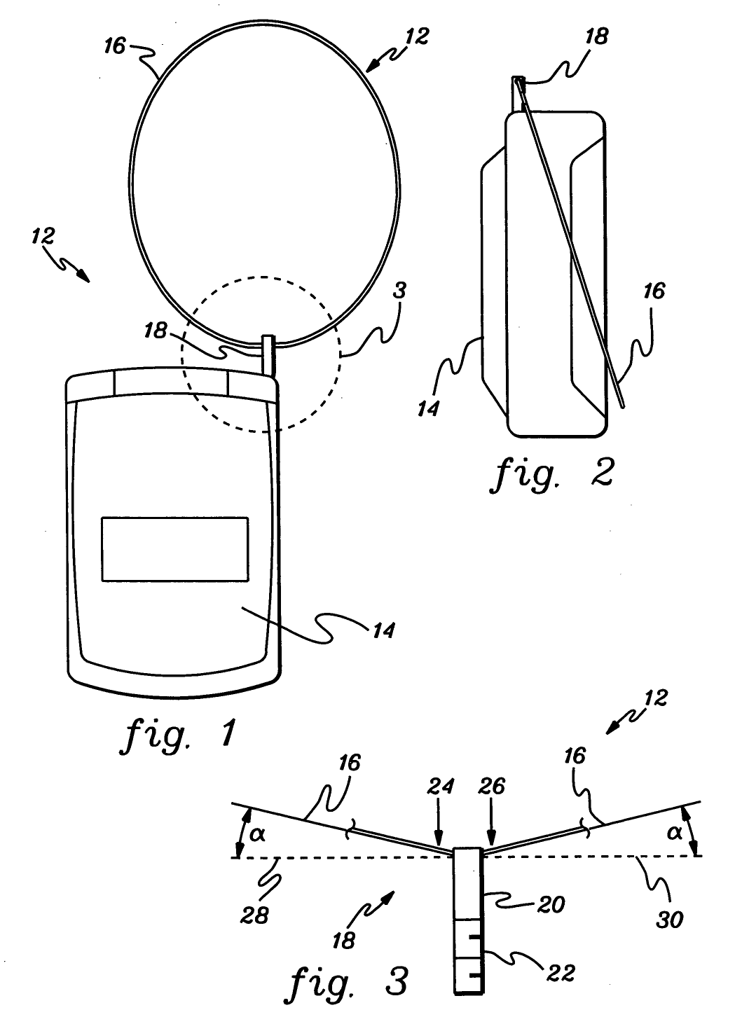

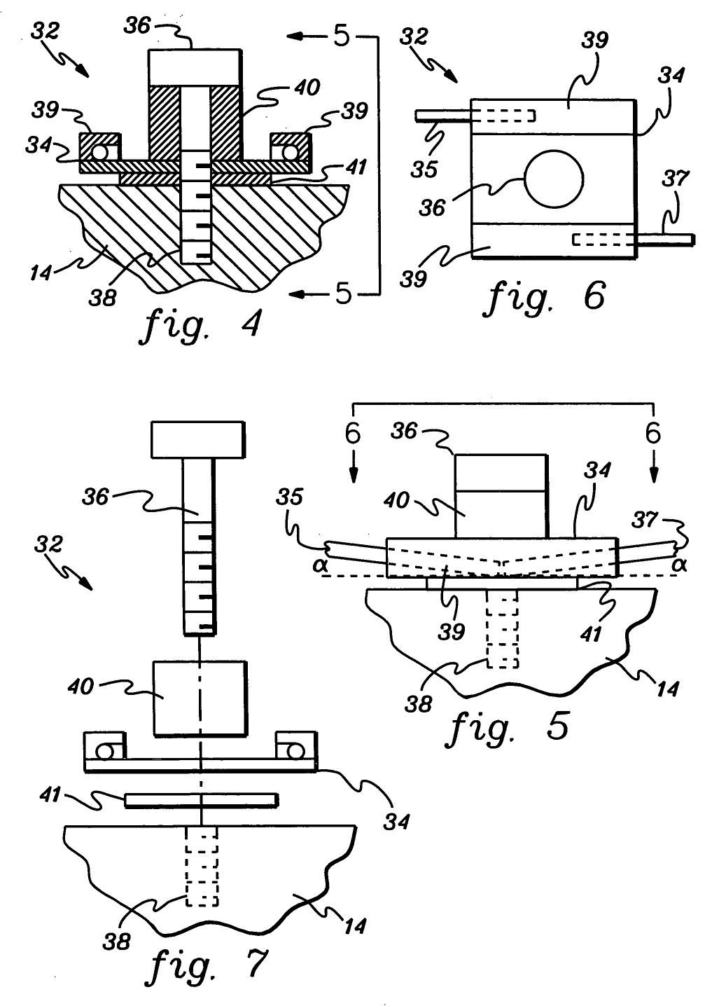

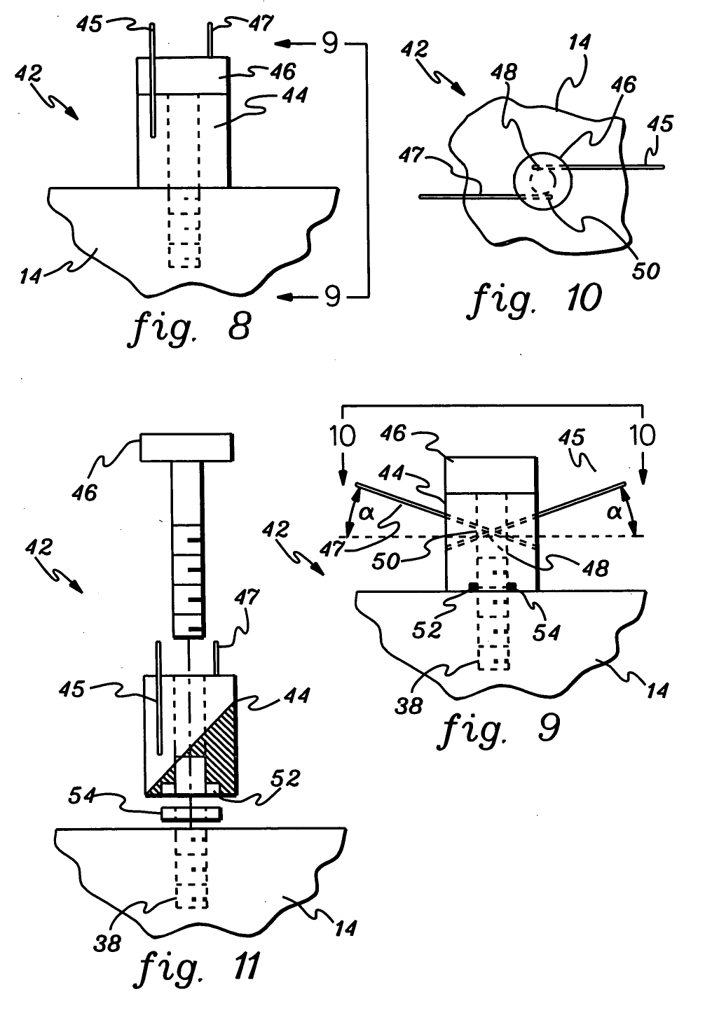

The details and scope of the aspects of the present invention can best be understood upon review of the attached figures and their following descriptions. FIG. 1 is a plan view illustrating an assembly 10 employing a device 12 according to one aspect of the invention as mounted to, for example, a cell phone 14. In FIG. 1, device 12 is shown in the extended, free, or undeformed position. FIG. 2 is a side elevation view of assembly 10 shown in FIG. 1. In FIG. 2, device 12 is shown in the contracted, constrained, or deformed position. Though in the following discussion aspects of the invention will be described in conjunction with their use with a cell phone, the present invention is not limited for use with a cell phone. For instance, a according to aspects of the present invention, device 12, may be used with any electronic or non-electronic device. For example, aspects of the present invention may be used with the following electronic devices: cell phones, personal digital assistants (PDAs), computers, electric power tools, radios, Ipod™ audio devices, and MP3 players, among others. Aspects of the present invention may also be used for one or more of the following non-electronic devices: hand tools; wallets; and writing utensils, such as pens.

According to one aspect of the invention, device 12 includes or comprises a wire loop 16 and a mounting device 18 for mounting device 12 to cell phone 14. According to one aspect of the invention mounting device 18 is adapted to allow wire loop 16 to extend as shown in FIG. 1 and retract as shown in FIG. 2. For example, in one aspect of the invention, mounting device 18 is adapted to allow wire loop 16 to be contracted, for example, manually by a user, as shown in FIG. 2 and self-extended as shown in FIG. 1, for example, under the elastic force of wire loop 16 or mounting device 18. That is, in one aspect, of the invention, device 18 is easily contractible and stored by the user, for example, in a pocket, and then automatically extended when removed from storage, for example, when removed from a pocket. In one aspect of the invention, device 12 provides a handle, an antenna, or a combination of a handle and an antenna. Mounting device 18 may provide for fixed mounting of wire loop 16 to device 14 or non-fixed mounting, for example, mounting device 18 may allow wire loop 16 to swivel about an axis, for example, about an axis directed substantially normal to the surface of device 14. In one aspect of the invention, mounted device 18 may be adapted to allow rotation of wire loop 16 about an axis substantially parallel to the surface of device 14. In one aspect of the invention, wire loop 16 may comprise a relatively rigid wire that would not readily deflect if rigidly mounted to mounting device 18. In this aspect of the invention, wire loop 16 may not be rigidly mounted to mounting device 18, but may be rotatably mounted to mounting device 18, for example, wire loop 16 may comprise a continuous wire that passes through an aperture in mounting device 18 and may rotate within the aperture in mounting device 18. In one aspect of the invention, wire loop 16 may be a non-continuous wire, for example, a wire having ends that overlap, for instance, ends that overlap in the vicinity of or when passing through the aperture in mounting device 18. According to this aspect of the invention, the overlap of the discontinuous wire, for example, at least about one-quarter inch over lap, may provide flexibility whereby wire loop 16 may self-erect when released from a contracted state. In one aspect, of the invention, the continuous or discontinuous wire with overlap may make an angle greater than zero degrees with the horizontal at or near the mounting device 18, for example, an angle of at least about 5 degrees. In one aspect of the invention, the continuous or discontinuous wire with overlap may comprise spring steel.

FIG. 3 provides a detailed view of one mounting device 18 shown in FIGS. 1 and 2 identified by detail 3 in FIG. 1, which according to one aspect of the present invention makes aspects of the invention possible. As shown in FIG. 3, according to one aspect of the invention, mounting device 18 comprises a pin 20 to which wire loop 16 is mounted. Pin 20 may include means for mounting pin 20 to cell phone 14, for example, pin 20 may include threads 22 which can be threaded into a threaded aperture in cell phone 14, for example, into a threaded antenna aperture. However, pin 20 may be mounted to cell phone 20 by many different means, including, an adhesive, mechanical fasteners, or integrally mounted by means of welding or brazing. In one aspect of the invention, pin 20 may engage cell phone 14 by means of a device which releasably engages. For example, in one aspect, pin 20 may include a detent, for example, a spring-loaded detent, that may engage a corresponding structure in an aperture in cell phone 14. The spring-loaded structure may be associated with pin 20 or with cell phone 14. In one aspect, pin 20 may engage cell phone 14 by means of a snap-in configuration, for example, the above-mentioned detent. In one aspect, the snap-in or detent may be actuated or released by the user, for example, by depressing a button or a release to disengage pin 20 from cell phone 14. Examples of other means for mounting wire loop 16 to a cell phone are presented in FIGS. 4 though 15.

According to one aspect of the invention, wire loop 16 comprises two ends 24 and 26, and wire loop ends 24 and 26 may be mounted to pin 20 whereby at the point of attachment the axes of wire loop ends 24 and 26 make an angle α with the horizontal, as indicated by phantom lines 28 and 30. According to this aspect of the invention, the attachment of wire loop ends 24 and 26 to pin 20 at angle α provides a least some resiliency to wire loop 16, whereby after being contracted, for example, as shown in FIG. 2, and then released, wire loop 16 self-extends, or “springs”, into an extended position, for example, as shown in FIG. 1. According to one aspect of the invention, angle α may be about 0 degrees. In another aspect of the invention, angle α may be greater than about 0 degrees, for example, at least greater than 0 degrees. According to another aspect of the invention, angle α may vary from greater than 0 degrees to about 5 degrees. In another aspect of the invention, angle α may vary from greater than 0 degrees to about 10 degrees. In another aspect of the invention, angle α may vary from greater than 0 degrees to about 20 degrees, or even 30 or 45 degrees. In one aspect, angle α may be about 90 degrees. In one aspect of the invention, angle α between wire loop ends 24 and horizontal line 28 and wire loop end 26 and horizontal line 30 may be substantially the same; however, in one aspect of the invention, angle α between wire loop ends 24 and horizontal line 28 and wire loop end 26 and horizontal line 30 may be different, for example, at least about 1 degree different, or at least about 5 degrees different.

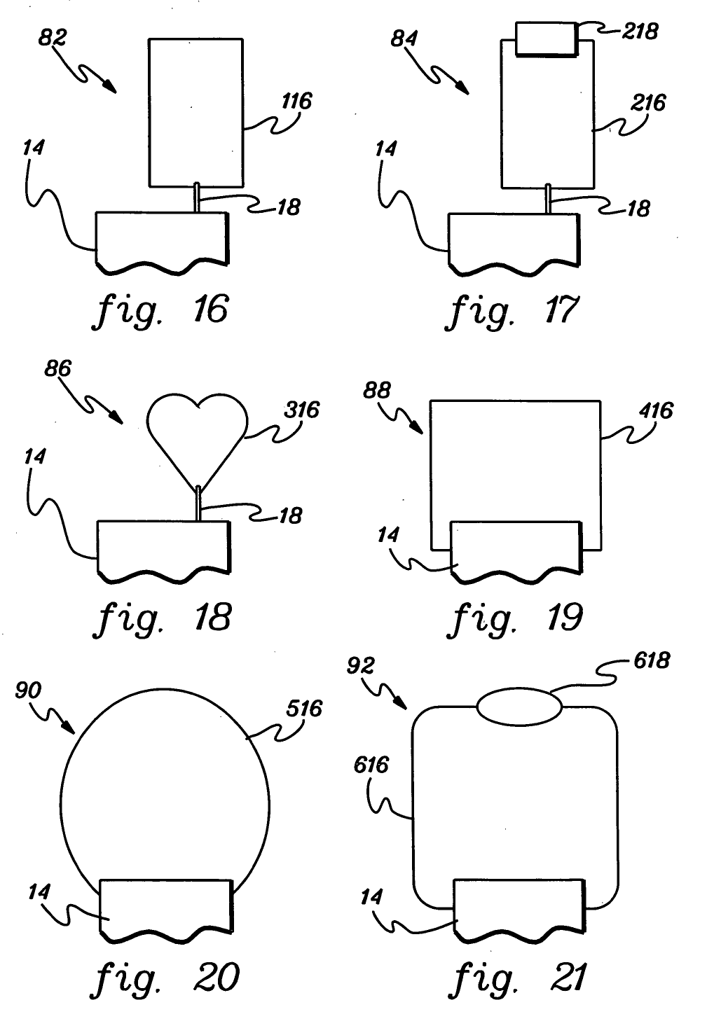

According to one aspect of the invention, wire loop 16 may take many forms. However, in one aspect of the invention wire loop 16 may take a form that is readily graspable, for example, readily graspable to a user of cell phone 14, or any other device to which device 12 is mounted. In one aspect of the invention, wire loop 16 may take the form of one of the shapes illustrated in FIGS. 16 through 21.

In one aspect of the invention, wire loop 16 may be continuous, for example, continuous and uninterrupted. That is, in one aspect of the invention one end of wire loop 16 may be mounted to mounting device 18 and the other end of wire loop 16 may be mounted to mounting device 18 whereby wire loop provides a continuous, uninterrupted extension of wire. In another aspect of the invention, wire loop 16 may be interrupted, for example, wire loop 16 may not be continuous but be interrupted by one or more structures, for example, one or more rings, one or more beads, one or more blocks may be mounted between one end of wire loop 16 and the other end of wire loop 16. These one or more structures that may make wire loop 16 more easily graspable. Examples of this aspect of the invention are illustrated in FIGS. 16 through 21

Though wire loop 16 is referred to as “a wire”, wire loop 16 may be comprised of many different materials and material configurations. Wire loop 16 may be metallic or non-metallic. For example, wire loop 16 may be made from one or more of the following metals: iron, steel, stainless steel, spring steel, aluminum, titanium, nickel, magnesium, or any other structural metal or a combination of these metals. In one aspect of the invention, wire loop 16 may be made from copper, silver, gold, or a combination thereof. In another aspect of the invention, wire loop 16 may be non-metallic, for example, made from a plastic, such as nylon, polyethylene (PE), polypropylene (PP), polyester (PE), polytetraflouroethylene (PTFE), acrylonitrile butadiene styrene (ABS), among other plastics or a combination of these plastics. In one aspect of the invention, wire loop 16 may be made from carbon fiber. In the aspect of the invention where wire loop 16 is metallic, wire loop 16 may be coated or uncoated, for example, wire loop 16 may be coated with one or more of the plastics identified above. Wire loop 16 may also be made from twisted wire, for example, twisted metal wire or twisted plastic cord or thread. In one aspect of the invention, wire loop 16 may comprise multi-strand wire or cable, for example, wherein at least one of the wire strands may conduct electric power, for example, to power one or more lights mounted on wire loop 16.

FIG. 4 is a side elevation view, partially in cross-section, of a mounting arrangement 32 according to another aspect of the invention as mounted into cell phone 14. FIG. 5 is side elevation view, partially in cross section, of mounting arrangement 32 are shown in FIG. 4 as viewed along view lines 5-5. FIG. 6 is plan view of mounting arrangement 32 shown in FIG. 5 as viewed along view lines 6-6 and FIG. 7 is an exploded view of the mounting arrangement 32 own in FIGS. 4, 5 and 6. According to this aspect of the invention, mounting arrangement 32 includes a mounting bracket 34 and a threaded connector 36 for threading into a threaded hole 38 in cell phone 14 to mount mounting bracket 32. According to one aspect of the invention, threaded hole 38 may be the antenna-mounting hole of cell phone 14, though any threaded hole in cell phone 14 may be used.

According to one aspect of the invention, mounting bracket 34 may be adapted to retain wire loop ends 35 and 37. In this aspect of the invention, mounting bracket 34 may be fabricated with sleeves or ferrules 39 designed to retain wire loop ends 35 and 37. For example, as shown in FIG. 5, ferrules 39 may retain wire loop ends 35 and 37 at angle α, as described above. In one aspect, mounting bracket 34 may fabricated as a single integral part, for example, as a stamping or forging, and ferrules 39 may be fabricated during the mounting of wire loop ends 35 and 37, for example, by pressing or crimping. Wire loop ends 35 and 37 may be retained in ferrules 39 by conventional means, including by means of an adhesive, by means of a press fit, by means of a shrink fit, or by pressing or crimping. Mounting bracket 34 may be metallic or non-metallic, for example, mounting bracket 34 may be fabricated from one or more of the metals or plastics referenced above.

As shown in FIGS. 4-7, in one aspect of the invention, mounting arrangement 32 may include one or more bushings 40, for example, one or more circular cylindrical or rectangular cylindrical bushings. Bushing 40 may be used to assist in mounting mounting bracket 34 to device 14 using threaded connector 36. For example, in one aspect, bushing 40 may be sized to consume the clearance between the height of connector 36 and mounting bracket 34. In one aspect of the invention, bushing 40 may be integral with mounting bracket 34, for example, welded or glued to bracket 34, or otherwise fabricated as an integral component, for example, by stamping or forging. In another aspect of the invention, bushing 40 may be omitted, for example, where the length of connector 36 is shorter, for instance, where little or no clearance exists between the height of connector 36 and mounting bracket 34. Bushing 40 may be metallic or non-metallic, for example, bushing 40 may be fabricated from one or more of the metals or plastics referenced above.

In another aspect of the invention, mounting arrangement 32 may also include one or more washers 41. Washer 41 may be metallic or non-metallic, but in one aspect of the invention, washer 41 is made from a resilient material, for example, a rubber or one or more of the plastics referenced above. According to one aspect of the invention, washer 41 is provided to supply a resilient interface between bracket 34 and device 14, for example, to prevent damaging or scratching device 14. In one aspect of the invention, washer 41 may be omitted.

FIG. 8 is a side elevation view, partially in cross-section, of a mounting arrangement 42 according to another aspect of the invention. FIG. 9 is side elevation view, partially in cross-section, of mounting arrangement 42 shown in FIG. 8 as viewed along view lines 9-9. FIG. 10 is plan view of mounting arrangement 42 shown in FIG. 9 as viewed along view lines 10-10 and FIG. 11 is an exploded view of mounting arrangement 42 shown in FIGS. 8, 9, and 10. According to this aspect of the invention, mounting arrangement 42 includes a wire mounting bushing 44 and a threaded connector 46 for threading into a threaded hole 38 in cell phone 14 to mount wire mounting bushing 44. Again, according to one aspect of the invention, threaded hole 38 may be the antenna mounting hole of cell phone 14, though any threaded hole in cell phone 14 may be used.

According to one aspect of the invention, wire mounting bushing 44, similar to mounting bracket 34, may be adapted to retain wire loop ends 45 and 47. In this aspect of the invention, wire mounting bushing 44 comprises at least two bores 48 and 50 (shown in phantom in FIGS. 9 and 10) into which wire loop ends 45 and 47 may be inserted and retained. Bores 48 and 50 may be blind holes or through holes in bushing 44. In one aspect of the invention, wire loop ends 45 and 47 may be retained in bores 48 and 50 by means of an adhesive, by means of a press fit, by means of a shrink fit, or by pressing or crimping. Again, bores 48 and 50 may retain wire loop ends 45 and 47 at angle α, as described above. Wire mounting bushing 44 may be metallic or non-metallic, for example, wire mounting bushing 44, may be fabricated from one or more of the metals or plastics referenced above.

As shown in FIGS. 9 and 11, in one aspect of the invention, wire mounting bushing 44 may include a recess 52, for example, an annular recess in the bottom of bushing 44, for locating a resilient ring 54, for example, an o-ring. In one aspect of the invention, recess 52 may have an outer surface that is beveled or non-beveled. Similar to washer 41 in FIGS. 4-7, resilient ring 54 may be used to provide a resilient interface between bushing 44 and device 14, for example, to prevent damaging or scratching device 14. Resilient ring 54 may be made from rubber, for example, neoprene, or EPDM, among others, or plastic, for example, one of the plastics referenced above. In one aspect of the invention, recess 52 in bushing 44 may not be concentric with the bore of bushing 44. In this aspect of the invention, the eccentric recess 52 causes resilient ring 54 to make contact with threaded fastener 36, for example, to promote or ensure electrical contact between bushing 44 and connector 46.

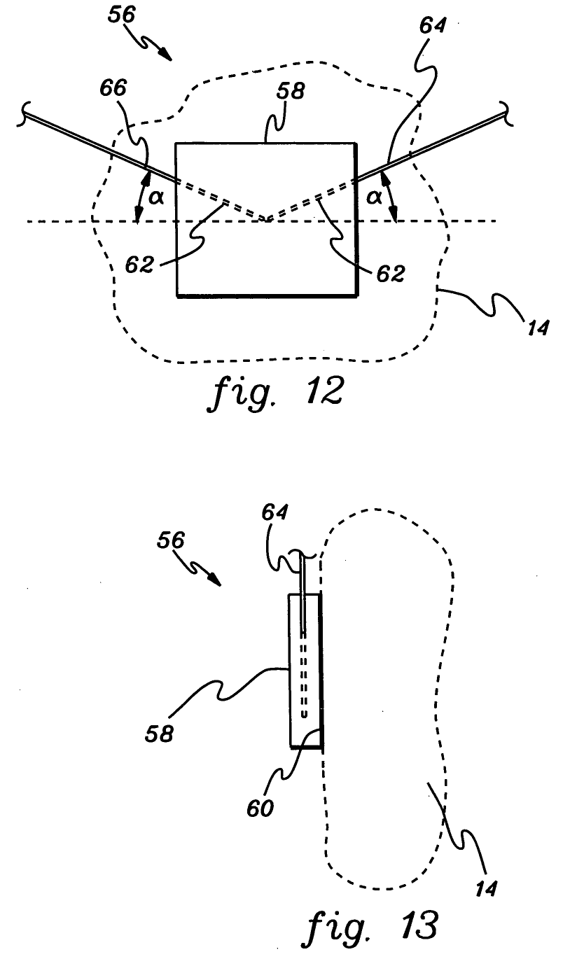

FIG. 12 is a plan view of a mounting assembly 56 according to another aspect of the invention. FIG. 13 is a side view of mounting assembly 56 shown in FIG. 12. In this aspect of the invention, mounting assembly 56 includes mounting block 58 and a means 60 for attaching mounting block 58 to device 14 (a partial view of which is shown in phantom in FIGS. 12 and 13). According to this aspect of the invention, mounting block 58 includes at least two bores or channels 62 into which wire loop ends 64 and 66 may be inserted and retained. Channels 62 may be blind holes or through holes in mounting block 58. In one aspect of the invention, wire loop ends 64 and 66 may be retained in channels 62 by means of an adhesive, by means of a press fit, by means of a shrink fit, or by pressing or crimping. Again, channels or bores 62 may retain wire loop ends 64 and 66 at angle α, as described above. Mounting block 58 may be metallic or non-metallic, for example, mounting block 58 may be fabricated from one or more of the metals or plastics referenced above.

Means 60 for mounting mounting block 58 to device 14 may comprise any conventional means for attaching mounting block 58 to device 14. In one aspect, means 60 may comprise an adhesive means, for example, means 60 may comprise an adhesive pad mounted to mounting block 58. For instance, means 60 may comprise a pad or sheet held to mounting block 58 by means of an adhesive and have a removal sheet that the user removes to expose a surface having an adhesive that can be used to mount mounting block 58 to device 14. In anther aspect of the invention, means 60 may comprise mechanical fastener means, for example, mounting block 58 may be mounted to device 14 by conventional mechanical fasteners, for example, one or more threaded fasteners or rivets, and the like. In one aspect of the invention, mounting block 58 may be mounted to device 14 by means of soldering, brazing, or welding, for example, when mounting block 58 comprises a fusible material, such as a metal or plastic.

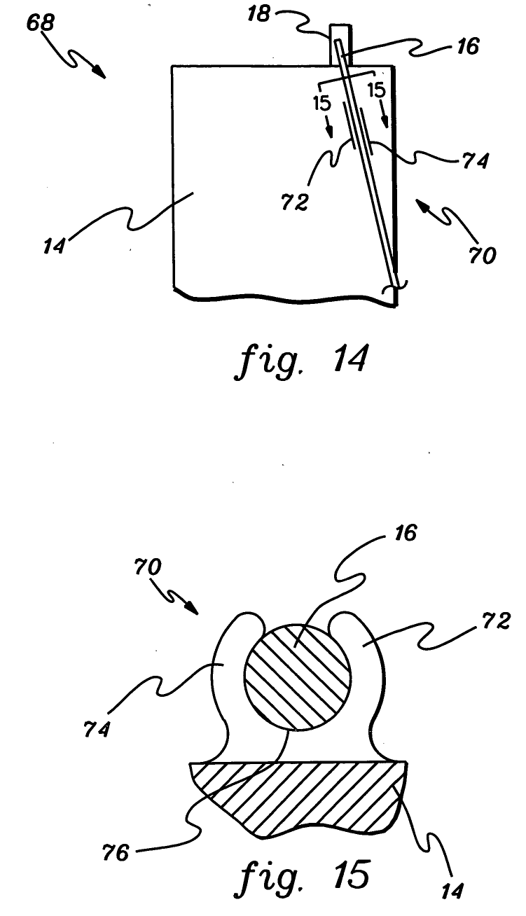

FIG. 14 is side elevation view of another arrangement 68 according to another aspect of the invention. Arrangement 68 comprises an additional means for mounting or an auxiliary means for mounting a wire loop 16 to a device 14. In this aspect of the invention, wire loop 16 may be retained to device 14 by at least one retaining means 70, for example, a crevice, indentation, détente, or protrusions on device 14. In one aspect of the invention, at least two retaining means 70 may be provided, for example, on opposite sides of device 14 whereby wire loop 16 may be retained at at least two locations. In one aspect of the invention, retaining means 70 may comprise at least one set of protrusions 72, 74 on device 14, for example, at least one set of elongated protrusions. FIG. 15 is a sectional view of retaining means 70 shown in FIG. 14 as viewed along view lines 15-15. In one aspect of the invention, protrusions 72, 74 may not be elongated, but may be small projections, for example, small hemispherical projections, from the surface of device 14. Protrusions 72, 74 may take any shape that is sufficient to provide a recess 76 into which wire loop 16 may rest and be at least partially retained by protrusions 72, 74. Protrusions 72, 74 may be rounded or angular, as shown. In one aspect of the invention, recess 76 may be provided by means of an indention in device 14, for example, an elongated depression or slot in device 14 adapted to at least partially retain wire loop 16.

According to one aspect of the invention, wire loop may take a broad array of shapes. In one aspect of the invention, wire loop 16 may comprise any wire-like structure that can be mounted to device 14, such as a cell phone, by means of mounting device 18 and be readily extendable. In one aspect of the invention, wire loop 16 comprises at least two wire ends that are mounted to mounting device 18, for example, a wire loop that contracts and self-extends as discussed above. Again, in one aspect of the invention, wire loop 16 may comprise a handle, an antenna, or a combination of a handle and an antenna. Various aspects of the invention are illustrated in FIGS. 16 through 21.

FIG. 16 illustrates one arrangement 82 for mounting a handle or antenna 116 onto a device 14 according to one aspect of the invention. In FIGS. 16 through 21, only a representative portion of device 14 is shown for ease of illustration. In this aspect, wire loop 116 may be mounted to device 14 by means of mounting device 18, for example, any one of the mounting devices described above. In this aspect, wire loop 116 comprises a rectangular shape that is mounted to mounting arrangement 18, for example, whereby the ends of wire loop 116 make an angle α with the horizontal, as described above. According to this aspect of the invention, wire loop 116 may take any closed shape, for example, polygonal closed shape, for example, a square, a rectangle, a hexagon, and the like. In one aspect, the corners of the polygonal shape may be rounded corners, for example, to prevent injury to the user.

FIG. 17 illustrates another arrangement 84 for mounting a wire loop 216 that is similar to wire loop 116 shown in FIG. 16 but includes at least one structure 218. Again, wire loop 216 may be mounted to device 14 by means of mounting device 18. According to this aspect of the invention, structure 218 may be any structure positioned on wire loop 216. In one aspect, structure 218 is adapted to make wire loop 216 easier to handle by the user, for example, for easily grasped by the user. Though shown as rectangular in shape, structure 218 may assume any shape. In one aspect of the invention, wire loop 216 passes through structure 218. In another aspect of the invention, the ends of wire loop 216 terminate somewhere on or in structure 218 and do not pass through structure 218. Structure 218 may comprise any one of the metallic or non-metallic materials referenced above. Structure 218 may include one or more means of illuminating structure 218, for example, one or more lights; structure 218 may also include a source of power for the one or more lights, for example, one or more batteries.

FIG. 18 illustrates another arrangement 86 for mounting a wire loop 316 that is similar to wire loop 116 shown in FIG. 16. Wire loop 316 comprises a heart shape that is typical of many of the shapes that can be used for wire loop 16, 116, 216, and 316 according to aspects of the invention. Again, wire loop 316 may be mounted to device 14 by means of mounting device 18.

FIGS. 19 and 20 illustrate further arrangements 88 and 90 for mounting wire loops 416 and 516 according to other aspects of the invention. According to these aspects of the invention, wire loops 416 and 516 may not be mounted to a mounting device, such as mounting device 18, but may be mounted by other means to the sides of device 14. In this aspect of the invention, the ends of wire loop 416 and 516 may be mounted to device 14 whereby the ends of wire loops 416 and 516 make an angle α with the plane perpendicular to the sides of device 14, as described above. For example, in one aspect, wire loops 416 and 516 may be mounted to device 14, for example, fixedly mounted, whereby the wire loop 316 is adapted to be self-extending when retracted.

FIG. 21 illustrates another arrangement 92 for mounting a wire loop 616 according to a still further aspect of the invention. According to these aspects of the invention, similar to wire loops 416 and 516 shown in FIGS. 19 and 20, wire loop 616 may be mounted to the sides of device 14, and also include at least one structure 618, which may be similar to structure 218 shown and discussed with respect to FIG. 17. Structure 618 may be mounted to wire loop 616 in a fashion similar to the way that structure 218 was described as being mounted to wire loop 216.

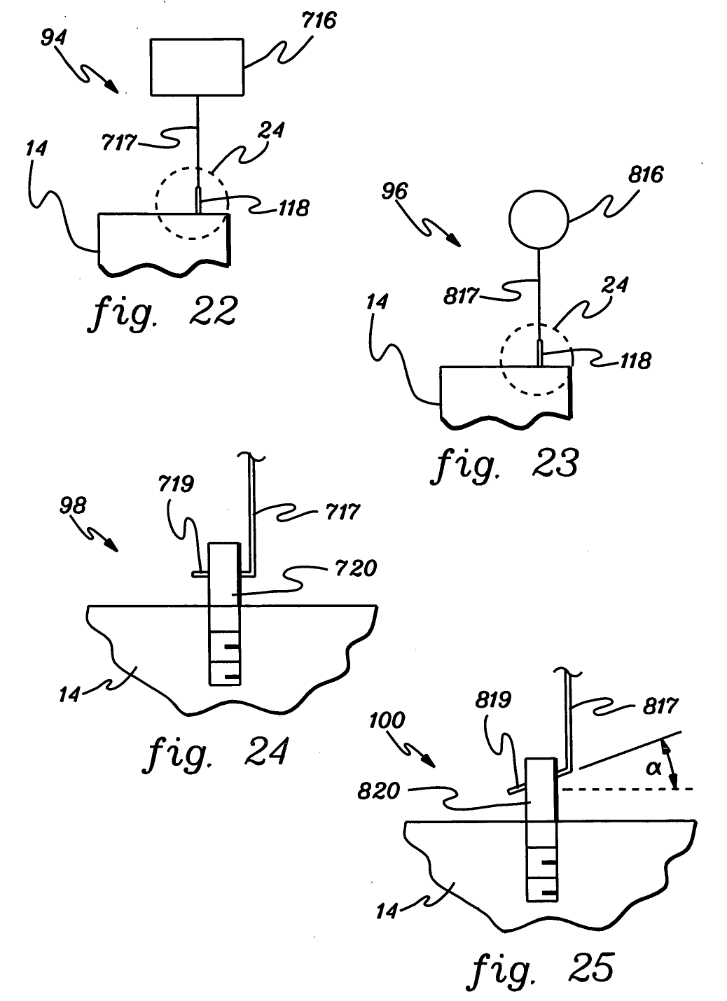

FIGS. 22 and 23 illustrate further arrangements 94 and 96 having wire loops 716 and 816, respectively, according to a still further aspect of the invention. In FIGS. 22 and 23, wire loops 716 and 816 are mounted to device 14 via wires 717 and 817, respectively. Wire loops 716 and 816 and wires 717 and 817, may be made from one or more of the materials and wire configurations discussed above with respect to wire 16 above. In this aspect of the invention, wires 717 and 817 are mounted to device 14 by means of mounting device 118.

FIGS. 24 and 25 illustrate detailed views of the mounting devices 98 and 100 that may be used for mounting device 118 in FIGS. 22 and 23. As shown in FIG. 24, mounting device 98 may comprise a mounting pin 720 mounted to device 14. For example, in one aspect of the invention, mounting pin 720 may be a threaded mounting pin that is threaded into a threaded hole in device 14, for example, a threaded antennae port. In this aspect, the end 719 of wire 717 is bent and then engaged with pin 720. For example, as shown, end 719 of wire 717 may be bent at about a 90-degree angle, and be mounted in a hole in pin 720. Wire end 719 may be mounted to pin 720 by conventional means, for example, by means of an adhesive, mechanical fasteners, or fusion (such as brazing or welding). As shown in FIG. 25, mounting device 100 may comprise a mounting pin 820 mounted to device 14. For example, in one aspect of the invention, mounting pin 820 may be a threaded mounting pin that is threaded into a threaded hole in device 14, for example, a threaded antennae port. In this aspect, the end 819 of wire 817 is bent and then engaged with pin 220. For example, as shown, end 819 of wire 817 may be bent at an angle α to the horizontal (shown in phantom) and be mounted in a hole in pin 820. Again, wire end 819 may be mounted to pin 820 by conventional means, for example, by means of an adhesive, mechanical fasteners, or fusion (such as brazing or welding).

It will be apparent to those of skill in the art that many difference types of enhancements, for example, decorative enhancements or structural enhancements may be made to one of more of the aspects of the invention illustrated and described. For example, aspects of the invention may include colored wire loops or colored structures, for example, trinkets or baubles, mounted to the wire loops. In another aspect of the invention, the wire loops or the structures may include lighting, such as LEDs and the like, for example, flashing lighting, or lighting that illuminates or flashes in response to an electrical signal, for example, when the cell phone rings. In one aspect of the invention, the structure mounted in the wire loop, for example, structure 218 or structure 618, may contain a power supply for the lighting, or a power supply for the device to which the loop or structure is mounted, or for both, for example, one or more batteries.

Aspects of the present invention provide a handle for handling a device, for example, a cell phone or a tool, that are improvements of existing handling devices. Aspects of the invention may also be used as antennas for electronic devices. In one aspect of the invention, a combination handle and antenna is provided that is unknown to the existing art. In one aspect of the invention, the handle, antenna, or handle/antenna combination is self-erecting, that is, the handle/antenna extends from a retracted position, without the need of a separate motive force or without the need for manipulation by the user.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. An article of manufacture comprising:
a mounting device adapted to mount to an object; and
a wire having a first end mounted to the mounting device and a second end mounted to the mounting device, wherein the wire is self-extending from a constrained, deformed position to an extended, undeformed position.

2. The article of manufacture as recited in claim 1, wherein the wire comprises one of a metallic and a non-metallic wire.

3. The article of manufacture as recited in claim 1, wherein the wire comprises a metallic wire antenna and the object comprises an electronic device.

4. The article of manufacture as recited in claim 1, wherein the article of manufacture comprises a handle and the object comprises an electronic device.

5. The article of manufacture as recited in claim 4, wherein the electronic device comprises an antenna mounting port, and wherein the mounting device is adapted to mount to the antenna mounting port.

6. The article of manufacture as recited in claim 1, wherein the mounting device comprises a mounting pin.

7. The article of manufacture as recited in claim 1, wherein the wire comprises a first end having an axis and a second end having an axis, and wherein the mounting device comprises an axis, and wherein the axis of the first end of the wire and the axis of the second end of the wire are mounted at an angle α to the axis of the mounting device.

8. The article of manufacture as recited in claim 7, wherein α is greater than 0 degrees.

9. The article of manufacture as recited in claim 8, wherein in α is greater than 0 and less than about 30 degrees.

10. The article of manufacture as recited in claim 1, wherein the object comprises one of an electronic device and a non-electronic object.

11. The article of manufacture as recited in claim 1, wherein the article further comprises means for retaining the wire in the deformed position.

12. A method for handling an object, the method comprising:
providing an article of manufacture comprising:
a mounting device adapted to mount to the object; and
a wire having a first end mounted to the mounting device and a second end mounted to the mounting device;
mounting the article of manufacture to the object;
collapsing the wire of the article of manufacture to a deformed position; and
inserting the object with the wire in the deformed position into a cavity.

13. The method as recited in claim 12, wherein the mounting device comprises a threaded mounting device and the object comprises a threaded port, wherein mounting the mounting device to the article comprises threading the threaded mounting device into the threaded port of the object.

14. The method as recited in claim 12, wherein collapsing the wire to a deformed position comprises bending the wire about the object.

15. The method as recited in claim 12, wherein the cavity comprises one of a pocket, a bag, a box, and a compartment.

16. The method as recited in claim 12, wherein the method further comprises retaining the wire in the deformed position.

17. An antenna for a cell phone having an antenna mounting port, the antenna comprising:
a mounting device adapted to mount to the antenna mounting port of the cell phone; and
a wire having a first end mounted to the mounting device and a second end mounted to the mounting device;
wherein the wire is self-extending from a constrained, deformed position to a free, undeformed position.

18. The antenna as recited in claim 17, wherein the mounting device comprises a mounting pin having an axis and wherein the first end and the second end of the wire are mounted at an angle α to the axis of the mounting pin.

19. The antenna as recited in claim 18, wherein α is greater than 0 degrees.

20. The antenna as recited in claim 17, wherein the antenna also comprises a handle for the cell phone.

21. The article of manufacture as recited in claim 1, wherein the mounting device comprises a mounting block, wherein the mounting block comprises means for mounting the mounting block to the object.

22. The article of manufacture as recited in claim 21, wherein the means for mounting the mounting block to the object comprises at least one of adhesive means, mechanical fastener means, soldering means, brazing means, and welding means.
